(19) United States
(12) Patent Application Publication
(10) Pub. No.: US 2017/0244307 A1
(43) Pub. Date: Aug. 24, 2017

(54) ELECTRIC APPARATUS

(71) Applicant: TOYOTA JIDOSHA KABUSHIKI KAISHA, Toyota-shi, Aichi-ken (JP)

(72) Inventor: Takashi MATSUMOTO, Toyota-shi (JP)

(73) Assignee: TOYOTA JIDOSHA KABUSHIKI KAISHA, Toyota-shi, Aichi-ken (JP)

(21) Appl. No.: 15/521,664

(22) PCT Filed: Aug. 31, 2015
(86) PCT No.: PCT/JP2015/004407

§ 371 Date: Apr. 25, 2017

(30) Foreign Application Priority Data
Oct. 27, 2014 (JP) 2014-218466

(51) Int. Cl. H02K 15/02; H02K 5/24

(52) U.S. Cl. CPC H02K 15/028; H02K 5/24

(57) ABSTRACT

A bolt hole (24) penetrating in a direction of lamination of electrical steel sheets is opened in a core (10). The core (10) is fixed to a case (12) by means of a clamping bolt (14) inserted into the bolt hole. A flanged bush (32) is inserted into the bolt hole from an end face of the core into which the clamping bolt (14) is to be inserted. A tubular portion (34) of the flanged bush is inserted into the bolt hole so as to engage two or more electrical steel sheets. A portion of the bolt hole engaging with the tubular portion has a structure that blocks relative rotation. Rotational force generated by fastening the clamping bolt is dispersed into a plurality of electrical steel sheets and, as a result, force exerted on one electrical steel sheet becomes smaller, which in turn prevents deformation.

### TECHNICAL FIELD

This invention relates to an electric apparatus, such as an electric motor, a power generator, or a transformer, and, more particularly, to a technique of fixing a core of the apparatus.

### BACKGROUND ART

An electric apparatus, such as an electric motor, a power generator, or a transformer, has a core to work as a magnetic path through which a magnetic flux passes. The core is typically made by laminating thin electrical steel sheets. Patent Literature 1 given below shows a technique of fixing a core (a stator core), which is made by laminating electrical steel sheets (1′), to a case (5). The core has holes (1e) penetrating in a direction of lamination of the electrical steel sheets. The core is fixedly clamped to the case with bolts (6) inserted into each of the holes. Parenthesized numerals are those used in Patent Literature 1 and are irrelevant to reference numerals used in a description of embodiment of the present patent application.

### CITATION LIST

### Patent Literature

PTL 1: JP 2013-128339 A

### SUMMARY OF INVENTION

### Technical Problem

When the core is fixed with the bolts inserted into the holes passing through the core, the electrical steel sheets at respective ends of the core are often dragged and deformed by rotation of bolt heads at the time of fastening the bolts.

The purpose of this invention is to prevent deformation of the electrical steel sheets, which would otherwise occur when the bolts are fastened.

### Solution to Problem

In an electric apparatus of this invention, a flanged bush is inserted into a bolt hole, which is provided in a core and into which a clamping bolt is to be inserted, from an end face of the core through which the clamping bolt is to be inserted. The core is clamped with the clamping bolt by way of the flanged bush. The flanged bush has a flange and a tubular portion, and the tubular portion is inserted into the bolt hole so as to engage with two or more electrical steel sheets. The tubular portion of the flanged bush and a portion of the bolt hole engaging with the tubular portion have a rotation blocking structure for blocking relative rotation.

Rotational force generated by fastening the clamping bolt propagates to the flanged bush and further to the two or more electrical steel sheets from the tubular portion of the bush. Since the rotational force of the bolt propagates to the two or more electrical steel sheets, force exerted on one electrical steel sheet decreases, which in turn prevents deformation of the electrical steel sheets.

The rotation blocking structure can be embodied as a structure which brings the tubular portion of the flanged bush and the bolt hole into an interference fit. In this case, the tubular portion of the flanged bush and the bolt hole assume a circular cross-sectional profile.

The rotation blocking structure can be embodied as a structure in which the tubular portion of the flanged bush and the bolt hole assume a non-circular cross-sectional profile. In this case, the cross-sectional profile can be; for instance, a polygon.

The flanged bush can be made of a nonmagnetic material.

The core can be a core of a motor-generator to work as either or both of an electric motor and a power generator. In this case, a target to which the core is to be fixed can be a case for housing the motor-generator.

### Advantageous Effects of Invention

The force generated by rotation of the clamping bolts at the time of fastening action propagates to the two or more electrical steel sheets by way of the flanged bushes, whereby force exerted on one electrical steel sheet decreases, which in turn prevents deformation of the electrical steel sheet.

### BRIEF DESCRIPTION OF DRAWINGS

FIG. 1 is an exploded perspective view showing a structure for fixing a core of a motor-generator.

FIG. 2 is a view of the motor-generator when viewed from a direction of a center axis thereof.

FIG. 3 is a cross-sectional view taken along line A-A shown in FIG. 2.

FIG. 4 is a perspective view showing an example flanged bush.

FIG. 5 is a perspective view showing another example of the flanged bush.

### DESCRIPTION OF EMBODIMENTS

An embodiment of this invention will be hereunder described by reference to the drawings. In the following, the embodiment is described by taking, as an example, a motor-generator which is an electrical apparatus capable of transforming kinetic energy of rotation of a moving body into electric energy, and vice versa. This invention, however, is also applicable to a power generator which transforms kinetic energy into electric energy and an electric motor which transforms electric energy into kinetic energy. Moreover, the moving body is not limited to rotation, and this invention is also applicable to a so-called linear motor, and the like, which moves along a straight line or an arbitrary curve. Further, this invention is also applicable to a core of a transformer.

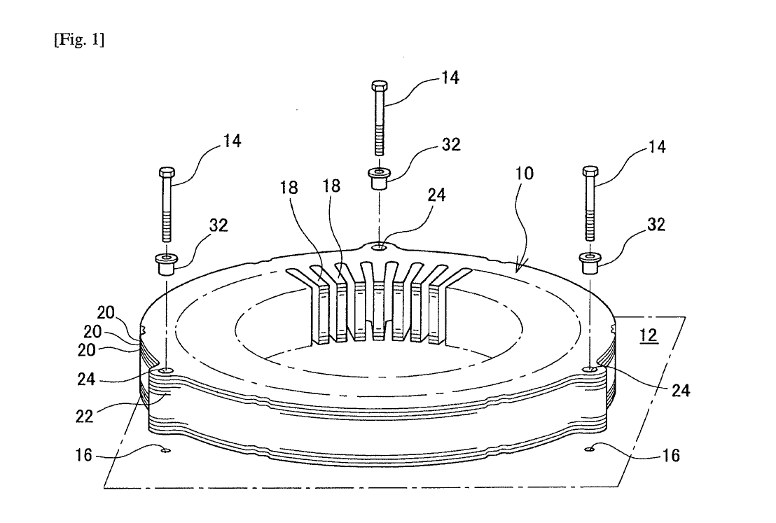

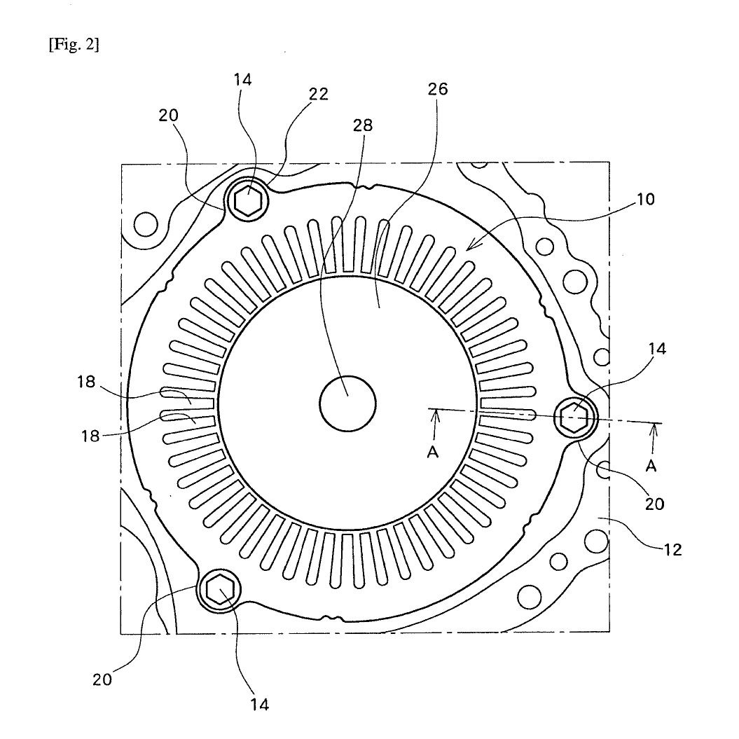

FIG. 1 is a view showing a structure for fixing a core 10 of a stator of the motor-generator. FIG. 2 is a view showing the motor-generator from above in FIG. 1 and in a direction of a center axis thereof. The center axis of the motor-generator is hereunder referred to simply as a center axis. The core 10 is fixed to a target of fixation; for instance, a case 12 for housing a stator of a motor-generator, with threaded clamping bolts 14. Tapped holes 16 are formed in the case 12, and threads on the clamping bolts 14 are screw-engaged with the tapped holes 16, thereby fixedly fastening the core 10. Although the core 10 is fixed, while being wound with a coil, to the case 12, the coil is omitted from FIGS. 1 and 2 for brevity.

The core 10 assumes a substantially-annular shape and has, along an inner circumference thereof, teeth 18 arranged along a circumferential direction. The teeth 18 are wound with a lead wire, thereby forming a coil. The core 10 is formed by laminating thin electrical steel sheets 20 in a direction of the center axis. Each of the electrical steel sheets 20 assumes the same shape as a cross section of the core 10 orthogonal to an axis thereof, and the core 10 having a thickness is formed by laminating the electrical steel sheets. An insulation layer is formed over a surface of each electrical steel sheet 20, whereby the electrical steel sheets 20 are insulated from each other. The laminated electrical steel sheets 20 are integrated by welding outer circumferences thereof along a direction of lamination. Eddy currents, which would otherwise be caused by the magnetic flux passing through an interior of the core 10, are prevented by adopting a laminated structure for the core 10, thereby reducing an iron loss.

Ridges 22, which stretch in parallel with the center axis, are formed on an outer circumference of the core 10. A bolt hole 24, which stretches in the direction of the center axis and passes through the core 10, is formed in each of the ridges 22. The clamping bolt 14 is inserted into each bolt hole 24. In order to prevent a magnetic path through which magnetic flux passes from becoming narrow, it is preferable to form the bolt hole 24 so as to fit in the ridge 22. However, the bolt hole can also be formed partly or entirely in an annular portion of the core. The bolt hole 24 can be provided at regular intervals at a plurality of locations along the circumferential direction. In the present embodiment, the bolt hole 24 is provided at regular intervals and three locations.

As shown in FIG. 2, a rotor 26 is disposed inside the annular core 10. The rotor 26 is integrated with a rotor shaft 28 and rotates along with the rotor shaft 28. The rotor shaft 28 acts as an output shaft when the motor-generator works as an electric motor and acts as an input shaft when the motor-generator works as a power generator.

The case 12 houses the stator and the rotor that make up the motor-generator. The case 12 may also house constituent elements of another apparatus together with constituent elements of the motor-generator. For instance, the case may also house a transmission mechanism of a transmission.

As mentioned previously, the core 10 is fixedly clamped by bringing the clamping bolts 14 into screw-engagement with the tapped holes 16 of the case. When the clamping bolts 14 are fastened, bolt heads 30 are rotated. When rotation propagates to the electrical steel sheets 20, force, such as that dragging the electrical steel sheets 20, acts on the electrical steel sheets 20. The force can sometimes deform the electrical steel sheets 20. When the bolt heads 30 come into direct contact with the electrical steel sheets 20, rotational force from the clamping bolts 14 acts on the electrical steel sheets 20. Further, even when a washer is interposed between the bolt and the electrical steel sheet, the rotational force from the clamping bolts 14 acts on the electrical steel sheets 20 by way of the washers. If the electrical steel sheets 20 become deformed as a result of being dragged by the bolt heads 30, adhesion among the electrical steel sheets will decrease, so that portions of the electrical steel sheets will lift themselves; in other words, clearance will arise in portions of the electrical steel sheets. If the lifted portions exist in the electrical steel sheets with the clamping bolts fastened, use of the motor-generator will be accompanied by collapse of the lifted portions, which in turn decreases axial tension of the clamping bolts. For instance, the core 10 is heated and expands during operation of the motor-generator, and force of expansion acts on the lifted portions of the electrical steel sheets so as to cause a collapse. Repetition of these actions results in collapse of the lifted portions, a reduction in core diameter, and a decrease in axial tension of the bolts. The decrease in axial tension of the bolts may cause faulty fixation of the core 10.

In the present embodiment, flanged bushes 32 to be inserted into the bolt holes 24 prevent deformation of the electrical steel sheets 20.

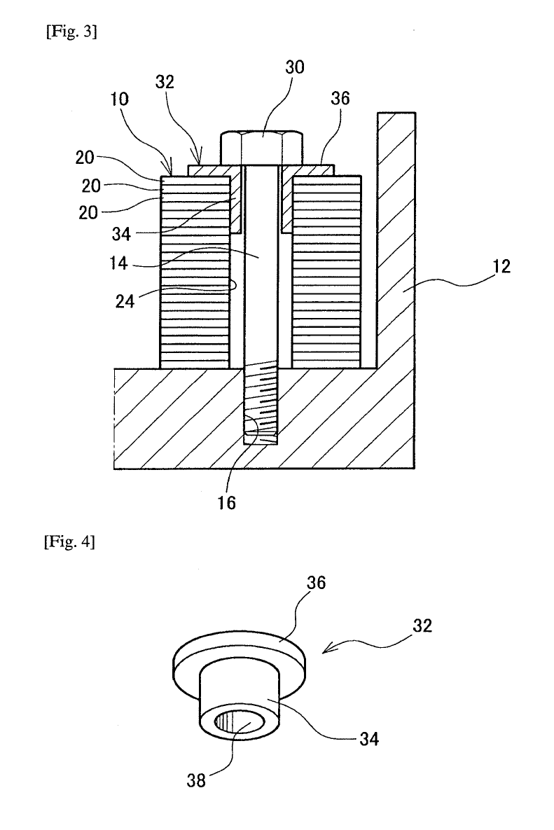

FIG. 3 is a cross-sectional view taken along line A-A in FIG. 2, and FIG. 4 is an illustration showing the flanged bushes 32 in the form of a single body. The flanged bush 32 has a tubular portion 34 and a flange 36, further including a through hole 38 which extends in the direction of the center axis of the bush 32 and penetrates through the bush 32. The tubular portion 34 is inserted into the bolt hole 24, whereby the flanged bush 32 is fitted into the core 10. The tubular portion 34 is inserted into the bolt hole 24 from an end face of the core 10 into which the clamping bolt 14 is to be inserted until the flange 36 comes into contact with the end face of the core 10. A length of the tubular portion 34 is double or more than double the thickness of the electrical steel sheet 20; for instance, an equivalent of more than ten electrical steel sheets. The flange 36 is sandwiched between the bolt head 30 and the core 10, thereby hindering direct contact between the bolt head 30 and the electrical steel sheet 20. An outer diameter of the flange 36 can be set to such an extent that the electrical steel sheet 20 will not be collapsed by axial tension generated by clamping action of the clamping bolt 14. A large outer diameter of the flange 36 contributes to dispersion of the axial tension over a wide extent, thereby preventing collapse and deformation of the electrical steel sheet 20. An inner diameter of the through hole 38 can be set to one which is larger than a diameter of a shaft and a diameter of a threaded portion of the clamping bolt 14 so as to allow easy insertion of the clamping bolt 14.

A cross-sectional profile of the tubular portion 34 perpendicular to a stretching direction of the tubular portion 34 is circular, and the bolt hole 24 also assumes a circular cross-sectional profile. The fit between the tubular portion 34 and the bolt hole 24 is an interference fit. Specifically, in a state where the flanged bush 32 is not yet fitted into the core 10, the outer diameter of the tubular portion 34 is larger than the inner diameter of the bolt hole 24. When the flanged bush 32 is fitted to the core 10, the tubular portion 34 exerts force on the bolt hole 24, thereby widening the bolt hole 24. With the aid of the force, the tubular portion 34 goes into close engagement with the bolt hole 24.

The interference fit can be realized by press-fitting the flanged bush 32. Alternatively, the fit can also be realized by means of a shrinkage fit; namely, through processes of heating the core 1, inserting the tubular 34 into the bolt hole 24 while holding the bolt hole 24 expanded, and subsequently eliminating a temperature difference.

The flanged bush 32 comes into engagement with the bolt hole 24 of the core 10 by means of bringing the flanged bush 32 and the bolt hole 24 into an interference fit, thereby blocking relative rotation. When the clamping bolt 14 is fastened, the bolt head 30 contacts the flange 36 of the flanged bush, whereupon force acts on the flange, thereby rotating the flange 36. By way of the tubular portion 34 of the flanged bush, the force also propagates not only to one electrical steel sheet 20 on an end face of the core but also to a plurality of electrical steel sheets 20 in engagement with the tubular portion 34. Accordingly, the rotational force of the clamping bolt 14 disperses throughout the plurality of electrical steel sheets 20, so that the force acting on one electrical steel sheet 20 becomes smaller. Deformation of the electrical steel sheets 20; particularly the electrical steel sheet 20 situated on the end face of the core, is thereby prevented.

As a result of deformation of the electrical steel sheet 20 being prevented, a decrease in axial tension of the bolt can be prevented. Further, destruction of an insulating layer between adjacent steel sheets, which would otherwise be caused by deformation of the electrical steel sheet 20, can be prevented. Moreover, the thickness of the electrical steel sheet 20 can be made further thinner as a result of the force exerted on one electrical steel sheet 20 becoming smaller. So long as the electrical steel sheet 20 is made thinner, a loss due to eddy currents will decrease, so that efficiency will be improved.

The flanged bush 32 can be made of a nonmagnetic material. Specifically, a non-magnetic metal; particularly, nonmagnetic stainless steel, such as austenitic stainless steel, can be used. Since the flanged bush 32 is in close contact with the core 10, a portion of the magnetic flux passing through the core 10 may pass through the flanged bush 32. However, the amount of magnetic flux passing through the flanged bush is reduced by making the flanged bush 32 of a nonmagnetic material, which can prevent occurrence of eddy currents. Deterioration of the iron loss can be prevented by reducing the eddy currents.

A coefficient of friction existing between the clamping bolt 14 and the flanged bush 32 can be increased by adoption of the flanged bush 32. The clamping bolt 14 can be sometimes coated with a friction coefficient stabilizer in order to stabilize a friction coefficient. Variations in friction coefficient among individual clamping bolts can be stabilized within a narrow range by application of the friction coefficient stabilizer. In order to prevent movement of the core 10 in a direction orthogonal to the center axis, a higher coefficient of friction between the clamping bolt 14 and the core 10 is preferable. Meanwhile, if the friction coefficient is high, rotational force generated by fastening the clamping bolt 14 will easily propagate to the electrical steel sheet 20 on the end face of the core, which would likely cause deformation of the electrical steel sheet 20. Resistance to deformation of the electrical steel sheet 20 is enhanced by adopting the flanged bush 32, so that a friction coefficient stabilizer having a higher degree of friction coefficient can be adopted. An effect of preventing movement of the core 10 can be enhanced by adoption of the friction coefficient stabilizer having a high friction coefficient.

The flanged bush 32 is engaged with the bolt hole 24 by means of the interference fit, thereby preventing relative rotation therebetween. The rotational force of the clamping bolt propagates to lower layers of the electrical steel sheets 20 as well as to the electrical steel sheet 20 on the top. In addition to this, there are other structures for blocking relative rotation between the flanged bush and the bolt hole 24. For instance, the cross-sectional profile of the tubular portion of the flanged bush and the cross-sectional profile of the bolt hole are made noncircular; preferably, identical with each other, whereby relative rotation between them can be blocked. An ellipse, a polygon, or the like can be mentioned as a specific cross-sectional profile. Polygons include convex polygons with vertical angles of less than 180° and concave polygons with at least one vertical angle of larger than 180°.

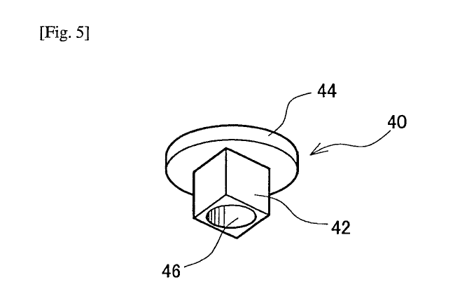

FIG. 5 shows a flanged bush 40 having a tubular portion with a polygonal cross-sectional profile. The flanged bush 40 has a tubular portion 42 and a flange 44 and, additionally, a through hole 46 through which the clamping bolt 14 is to pass. The flanged bush 40 has a structure similar to that of the flanged bush 32 except for a difference in cross-sectional profile of the tubular portion 42. A cross-sectional profile of the tubular portion 42 perpendicular to the axis is a square. At least a portion of the flanged bush, which will go into engagement with the tubular portion 42, is given a square cross-sectional profile having substantially the same size as that of the tubular portion 42. By means of the tubular portion 42 and the bolt hole having a square cross-sectional profile, relative rotation between the tubular portion 42 and the bolt hole is blocked. Consequently, it is not indispensable to fit the tubular portion 42 into the bolt hole by the interference fit. The flanged bush 40 can also be made of a non-magnetic material; particularly non-magnetic stainless steel.

### REFERENCE SIGNS LIST

10 CORE

12 CASE

14 CLAMPING BOLT

16 TAPPED HOLE

20 ELECTRIC STEEL SHEET

24 BOLT HOLE

32 FLANGED BUSH

34 TUBULAR PORTION

36 FLANGE

40 FLANGED BUSH

42 TUBULAR PORTION

44 FLANGE

1. An electric apparatus comprising:
a core which is made by laminating electrical steel sheets and has a bolt hole passing through the core in a direction of lamination;
a clamping bolt which fixes the core to a target of fixation by being inserted into the bolt hole, the clamping bolt fixing the core by sandwiching the core between a clamping bolt head and the target of fixation; and
a flanged bush inserted into the bolt hole from an end face of the core through which the clamping bolt is to be inserted, and having a flange which is in contact with the clamping bolt head, wherein
a tubular portion of the flanged bush is inserted into the bolt hole so as to engage with the two or more electrical steel sheets; and
the tubular portion of the flanged bush and the bolt hole engaging with the tubular portion have a rotation blocking structure.

2. The electric apparatus according to claim 1, wherein the rotation blocking structure is one bringing the tubular portion of the flanged bush and the bolt hole into an interference fit.

3. The electric apparatus according to claim 2, wherein the tubular portion of the flanged bush and the bolt hole assume a circular cross-sectional profile.

4. The electric apparatus according to claim 1, wherein the rotation blocking structure is a structure in which the tubular portion of the flanged bush and the bolt hole assume a non-circular cross-sectional profile.

5. The electric apparatus according to claim 4, wherein the tubular portion of the flanged bush and the bolt hole assume a polygonal cross-sectional profile.

6. The electric apparatus according to claim 1, wherein the flanged bush is made of a nonmagnetic metal material.

7. The electric apparatus according to claim 1, wherein
the electric apparatus is a motor-generator;
the core is a stator core of the motor-generator; and
the target of fixation is a case housing the motor-generator.
